(19) United States
(12) Patent Application Publication
(10) Pub. No.: US 2025/0175720 A1
(43) Pub. Date: May 29, 2025

(54) IMAGE SENSOR DEVICE AND OPERATION METHOD THEREOF

(71) Applicant: Samsung Electronics Co., Ltd., Suwon-si (KR)

(72) Inventor: Junoh KIM, Suwon-si (KR)

(73) Assignee: Samsung Electronics Co., Ltd., Suwon-si (KR)

(21) Appl. No.: 18/882,914

(22) Filed: Sep. 12, 2024

(30) Foreign Application Priority Data
Nov. 23, 2023 (KR) 10-2023-0164741

(51) Int. Cl. H04N 25/77

(52) U.S. Cl. CPC H04N 25/77

(57) ABSTRACT

An image sensor device that includes a pixel and a column line connected the pixel. The pixel includes a reset transistor connected between a power supply voltage and a floating diffusion node of the pixel; a transmission gate transistor connected between the floating diffusion node and a zeroth node of the pixel; a photodiode connected between the zeroth node and a ground voltage; a filler transistor connected between a filler voltage and the floating diffusion node; a source follower transistor connected between the power supply voltage and a first node; and a selection transistor connected between the first node and the first column line. The filler transistor is turned-on during a first time period, and the reset transistor is turned-on during a second time period after the first time period.

### CROSS-REFERENCE TO RELATED APPLICATIONS

This application claims priority under 35 U.S.C. § 119 to Korean Patent Application No. 10-2023-0164741 filed on Nov. 23, 2023, in the Korean Intellectual Property Office, the disclosure of which is incorporated by reference herein in its entireties.

### BACKGROUND

Example embodiments of the present disclosure relate to image sensors, and more particularly relate to image sensor devices and operation methods thereof.

An image sensor converts a light incident from the outside into an electrical signal. The image sensor may be classified as one of a complementary metal-oxide-oxide-semiconductor (CMOS) image sensor and a charge coupled device (CCD) image sensor.

In the field of CMOS image sensors, an analog-to-digital conversion (ADC) operation may be performed using a correlation double sampling (CDS) technique, to improve reliability of image data through noise removal. Accordingly, various techniques for noise removal when using the CDS technique are being studied.

### SUMMARY

Example embodiments of the inventive concepts provide an image sensor device having improved reliability and improved performance, and a method of operating the same.

Some example embodiments of the inventive concepts provide an image sensor device that includes a pixel and a column line connected the pixel; and a sensor controller connect to the pixel. The pixel includes a reset transistor connected between a power supply voltage and a floating diffusion node of the pixel; a transmission gate transistor connected between the floating diffusion node and a zeroth node of the pixel; a photodiode connected between the zeroth node and a ground voltage; a filler transistor connected between a filler voltage and the floating diffusion node; a source follower transistor connected between the power supply voltage and a first node; and a selection transistor connected between the first node and the first column line. The sensor controller turns on the filler transistor during a first time period, and turns on the reset transistor during a second time period after the first time period.

Some example embodiments of the inventive concepts further provide an image sensor device that includes a row driver that outputs a reset signal, a transmission signal, a selection signal, and a filler signal; and a pixel array including a first pixel connected to a first column line. The first pixel includes a reset transistor connected between a power supply voltage and a floating diffusion node of the first pixel, the reset transistor operating in response to the reset signal; a transmission gate transistor connected between the floating diffusion node and a zeroth node of the first pixel, the transmission gate transistor operating in response to the transmission signal; a photodiode connected between the zeroth node and a ground voltage, the photodiode sensing light to accumulate charges; a filler transistor connected between a filler voltage and the floating diffusion node, the filler transistor operating in response to the filler signal to connect the floating diffusion node to the filler voltage, and the filler voltage being lower than the power supply voltage; a source follower transistor connected between the power supply voltage and a first node, the source follower transistor operating in response to a voltage of the floating diffusion node; and a selection transistor connected between the first node and the first column line, the selection transistor operating in response to the selection signal.

Some example embodiments of the inventive concepts still further provide a method of operating an image sensor device using a sensor controller. The image sensor includes a pixel that outputs a pixel signal. The pixel includes a reset transistor connected between a power supply voltage and a floating diffusion node of the pixel, a transmission gate transistor connected between the floating diffusion node and a zeroth node of the pixel, and a filler transistor connected between a filler voltage and the floating diffusing node. The method includes turning on the filler transistor to reduce a voltage of the floating diffusion node from a first voltage to a second voltage lower than the first voltage; turning on the reset transistor to reset the floating diffusion node; and comparing a voltage of the pixel signal with a voltage of a ramp signal.

### BRIEF DESCRIPTION OF THE FIGURES

The above and other objects and features of the inventive concepts will become apparent in view of the following detailed description of example embodiments with reference to the accompanying drawings.

FIG. 1 is a block diagram illustrating an image sensor device, according to some example embodiments of the inventive concepts.

FIG. 2 is a diagram illustrating a partial configuration of an image sensor device of FIG. 1 as an example.

FIG. 3 is a circuit diagram illustrating an example of a pixel of FIG. 2.

FIG. 4 is a timing diagram for describing an operation of an image sensor device including a pixel of FIG. 3.

FIGS. 5A, 5B, 5C and 5D are diagrams for describing noise generated during an operation of FIG. 4.

FIGS. 6A and 6B are circuit diagrams illustrating other examples of a pixel of FIG. 2.

FIG. 7 is a timing diagram for describing an operation of an image sensor device of FIG. 1.

FIGS. 8A, 8B, 8C, 8D and 8E are diagrams for describing an operation of FIG. 7.

FIG. 9 is a timing diagram for describing another example of an operation of an image sensor device of FIG. 1.

FIG. 10 is a flowchart illustrating a method of operating an image sensor device, according to some example embodiments of the inventive concepts.

FIG. 11 is a block diagram of an electronic device including a multi-camera module.

FIG. 12 is a block diagram of a camera module of FIG. 11.

### DETAILED DESCRIPTION

Hereinafter, some example embodiments of the inventive concepts will be described clearly and in detail such that those skilled in the art may easily carry out the inventive concepts.

In the detailed description, components or function blocks corresponding to terms such as “block”, “unit”, “logic”, etc. may be implemented in the form of software, hardware, or a combination thereof.

When the terms “about” or “substantially” are used in this specification in connection with a numerical value, it is intended that the associated numerical value includes a manufacturing or operational tolerance (e.g., +10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., +10%) around the stated numerical values or shapes. When ranges are specified, the range includes all values therebetween such as increments of 0.1%.

Also, for example, “at least one of A, B, and C” and similar language (e.g., “at least one selected from the group consisting of A, B, and C”) may be construed as A only, B only, C only, or any combination of two or more of A, B, and C, such as, for instance, ABC, AB, BC, and AC.

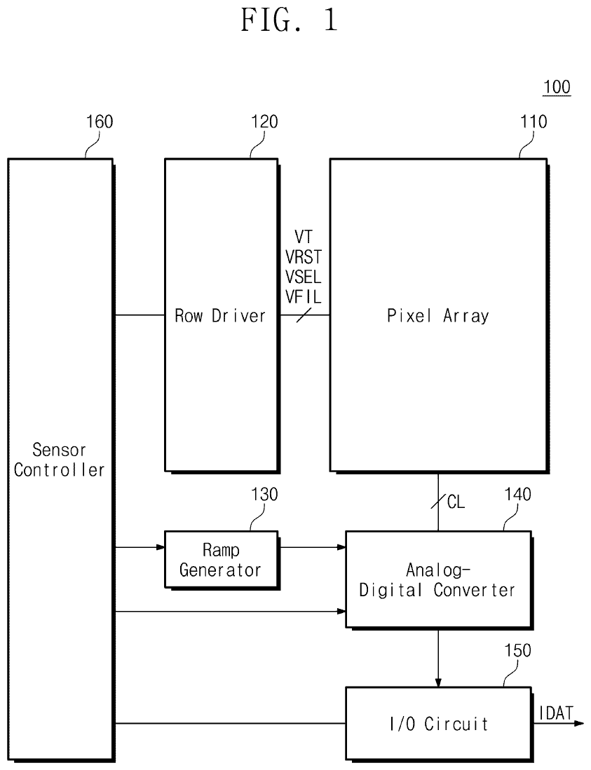

FIG. 1 is a block diagram illustrating an image sensor device, according to some example embodiments of the inventive concepts. Referring to FIG. 1, an image sensor device 100 may include a pixel array 110, a row driver 120, a ramp generator 130, an analog-digital converter 140, an input/output circuit 150, and a sensor controller 160.

The pixel array 110 may include a plurality of pixels arranged in a row direction and a column direction. Each of the plurality of pixels may generate a pixel signal in response to control of the row driver 120. Each of the plurality of pixels may output the generated pixel signal through column lines CL.

The row driver 120 may select and drive a row of the pixel array 110. The row driver 120 may be connected with the pixel array 110 through a plurality of signal lines. The row driver 120 may decode addresses generated by the sensor controller 160 and may generate control signals for selecting and driving a row of the pixel array 110. The row driver 120 may provide the control signals to each of the plurality of pixels through the plurality of signal lines. For example, the control signals may include a transmission signal VT, a selection signal VSEL, a filler signal VFIL, a reset signal VRST, etc.

The ramp generator 130 may generate a ramp signal under control of the sensor controller 160. For example, the ramp generator 130 may operate under a control signal, such as a ramp enable signal. When the ramp enable signal is activated, the ramp generator 130 may generate a ramp signal according to a value (e.g., a start level, an end level, a slope, etc.). For example, the ramp signal may be a signal that increases or decreases according to a slope during a specific time. The ramp signal may be provided to the analog-digital converter 140.

The analog-to-digital converter 140 may be connected to the pixel array 110 through the column lines CL. The analog-digital converter 140 may receive a pixel signal (e.g., an analog signal) from the column lines CL and may receive a ramp signal from the ramp generator 130. The analog-digital converter 140 may sample a pixel signal so as to be converted into a digital signal. For example, the analog-digital converter 140 may perform a reset sampling operation and a pixel sampling operation, and may output a difference between result values of each sampling operation as a pixel value (e.g., a digital signal).

The input/output circuit 150 may receive a digital signal from the analog-digital converter 140. The input/output circuit 150 may combine the received digital signals and may output final image data IDAT.

The sensor controller 160 may control the row driver 120, the ramp generator 130, the analog-digital converter 140, and the input/output circuit 150.

According to some example embodiments, each pixel of the pixel array 110 may include a filler transistor. The filler transistor may operate based on the filler signal VFIL from the row driver 120. The image sensor device 100 may turn on the filler transistor before performing a reset operation. The image sensor device 100 may inject charges (electrons) into a trap site of a pixel in advance based on the operation of the filler transistor. Accordingly, the image sensor device 100 may remove noise generated as charges of a floating diffusion node trapped in the trap site. Accordingly, the image sensor device 100 having improved reliability and improved performance may be provided. This will be described For example with reference to the drawings below.

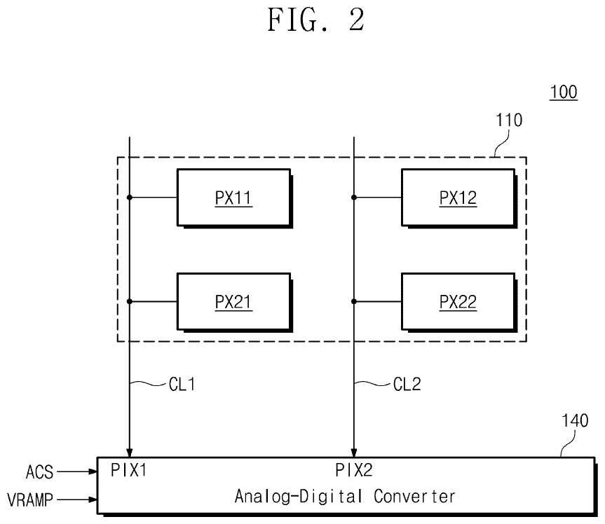

FIG. 2 is a diagram illustrating a partial configuration of an image sensor device of FIG. 1. For brevity of drawings and convenience of description, a partial configuration of the image sensor device 100 is illustrated, but the scope of the inventive concepts is not limited thereto. A plurality of pixels PX11 to PX22 of the pixel array 110 are illustrated as arranged in first to second rows and first to second columns, but the scope of the inventive concepts is not limited thereto, the plurality of pixels of the array 110 may be expanded in the row or column direction, and accordingly, additional pixels may be further included in the pixel array 110.

Referring to FIGS. 1 and 2, the image sensor device 100 may include the pixel array 110 and the analog-digital converter 140. The pixel array 110 may include the plurality of pixels PX11 to PX22. Among the plurality of pixels PX11 to PX22, the pixels PX11 and PX21 located in a first column may be connected to a first column line CL1, and the pixels PX12 and PX22 located in a second column may be connected to a second column line CL2.

In some example embodiments, the pixel array 110 may include various types of color filter arrays. For example, the pixel array 110 may include a color filter array configured to allow each pixel to receive a light signal corresponding to a given color. In some example embodiments, the color filter array may include at least one of various color filter array patterns such as a Bayer pattern, an RGBE pattern, a CYYM pattern, a CYGM pattern, a BGBW Bayer pattern, a BGBW pattern, and a tetra pattern.

The plurality of pixels PX11 to PX22 may generate first pixel signals PIX1 and second pixel signals PIX2. For example, among the plurality of pixels PX11 to PX22, the pixels PX11 and PX21 connected to the first column line CL1 may generate the first pixel signals PIX1, and the pixels PX12 and PX22 connected to the second column line CL2 may generate the second pixel signals PIX2.

The plurality of pixels PX11 to PX22 may output the first pixel signals PIX1 and the second pixel signals PIX2 to the first column line CL1 and the second column line CL2 in response to the selection signal VSEL.

In some example embodiments, the voltage of each of the first pixel signals PIX1 and the second pixel signals PIX2 may be a reset voltage generated through a reset operation of the corresponding pixel, or a data voltage generated through an integration operation.

The first and second column lines CL1 and CL2 may output the pixel signals PIX1 and PIX2 to the analog-digital converter 140.

The analog-to-digital converter 140 may be connected to the first and second column lines CL1 and CL2. The analog-digital converter 140 may receive the first and second pixel signals PIX1 and PIX2 from the first and second column lines CL1 and CL2, respectively. The analog-digital converter 140 may receive a ramp signal VRAMP from the ramp generator 130.

The analog-digital converter 140 may sample (e.g., convert to digital signals) the first and second pixel signals PIX1 and PIX2 in response to an ADC control signal ACS from the sensor controller 160. For example, the analog-digital converter 140 may perform a reset sampling operation and a data sampling operation in response to the ADC control signal ACS. The analog-digital converter 140 may obtain a reset sampling voltage through the reset sampling operation and may obtain a data sampling voltage through the data sampling operation.

The reset sampling voltage may be a voltage when the voltage of the ramp signal VRAMP is the same as the voltage (e.g., a reset voltage) of the pixel signals PIX1 and PIX2 after the reset operation is performed. The data sampling voltage may be a voltage when the voltage of the ramp signal VRAMP is the same as the voltage (e.g., a data voltage) of the pixel signals PIX1 and PIX2 after the integration operation is performed. The analog-digital converter 140 may generate a digital signal associated with an image based on a difference between the reset sampling voltage and the data sampling voltage.

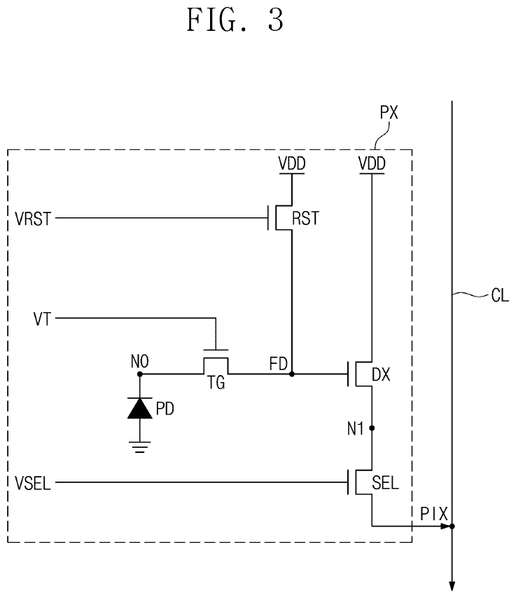

FIG. 3 is a circuit diagram illustrating an example of a pixel of FIG. 2. Referring to FIG. 3, a pixel with a 4TR-1PD (4-transistor and 1-photodiode) structure will be described. For example, the pixels PX11 to PX22 of FIG. 2 may have the same structure as a pixel PX of FIG. 3.

According to FIGS. 2 and 3, the pixel PX may output a pixel signal PIX to a column line CL in response to the reset signal VRST, the transmission signal VT, and the selection signal VSEL received from the row driver 120.

For example, the pixel PX may include a transmission gate transistor TG, a photodiode PD, a reset transistor RST, a driving transistor DX, and a selection transistor SEL.

The photodiode PD may be connected between a zeroth node NO and a ground voltage. The photodiode PD may be configured to accumulate charges in response to a light signal received from the outside. The transmission gate transistor TG may be connected between the zeroth node NO and a floating diffusion node FD. The transmission gate transistor TG may operate in response to the transmission signal VT from the row driver 120. For example, the transmission gate transistor TG may be turned-on in response to the transmission signal VT of a logic high (e.g., a logic high level). While the transmission gate transistor TG is turned-on in response to the transmission signal VT of the logic high, charges may be transferred from the photodiode PD to the floating diffusion node FD. Accordingly, a voltage level of the floating diffusion node FD may be lowered.

The reset transistor RST may be connected between a power supply voltage VDD and the floating diffusion node FD. The reset transistor RST may operate in response to the reset signal VRST from the row driver 120. For example, the reset transistor RST may be turned-on in response to the reset signal VRST of a logic high. While the reset transistor RST is turned-on in response to the reset signal VRST of the logic high, the floating diffusion node FD may be reset. Accordingly, the floating diffusion node FD may be charged with a reset voltage based on the power supply voltage VDD. For example, the reset transistor RST may generate a reset voltage in response to the reset signal VRST of the logic high.

The driving transistor DX may be connected between the power supply voltage VDD and a first node N1. The driving transistor DX may operate in response to a voltage of the floating diffusion node FD. For example, a gate terminal of the driving transistor DX may be connected to the floating diffusion node FD. In some example embodiments, the driving transistor DX may be configured to transfer the pixel signal PIX corresponding to the voltage change of the floating diffusion node FD to the selection transistor SEL through the first node N1. For example, the driving transistor DX may operate as a source follower of which input terminal is connected to the floating diffusion node FD. That is, a voltage level of the pixel signal PIX may be determined based on the voltage level of the floating diffusion node FD.

The selection transistor SEL may be connected between the first node N1 and the column line CL. The selection transistor SEL may operate in response to the selection signal VSEL from the row driver 120. For example, the selection transistor SEL may transmit the pixel signal PIX from the driving transistor DX to the column line CL in response to the selection signal VSEL of the logic high.

In some example embodiments, outputting the pixel signal PIX to transmit the voltage of the floating diffusion node FD to the column line CL through the driving transistor DX and the selection transistor SEL may be referred to as a readout operation. A process of turning on and off the transmission gate transistor TG to receive charges from the photodiode PD may be referred to as an integration operation. An operation of charging the floating diffusion node FD based on the power supply voltage VDD through the reset transistor RST may be referred to as a reset operation.

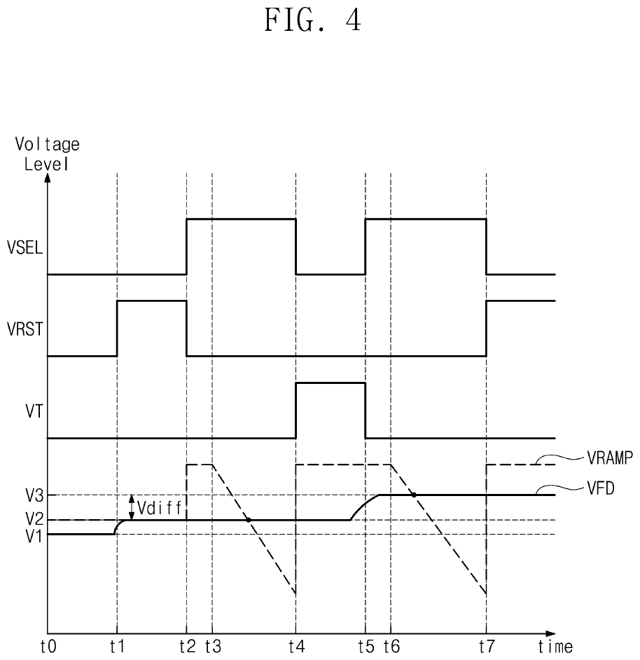

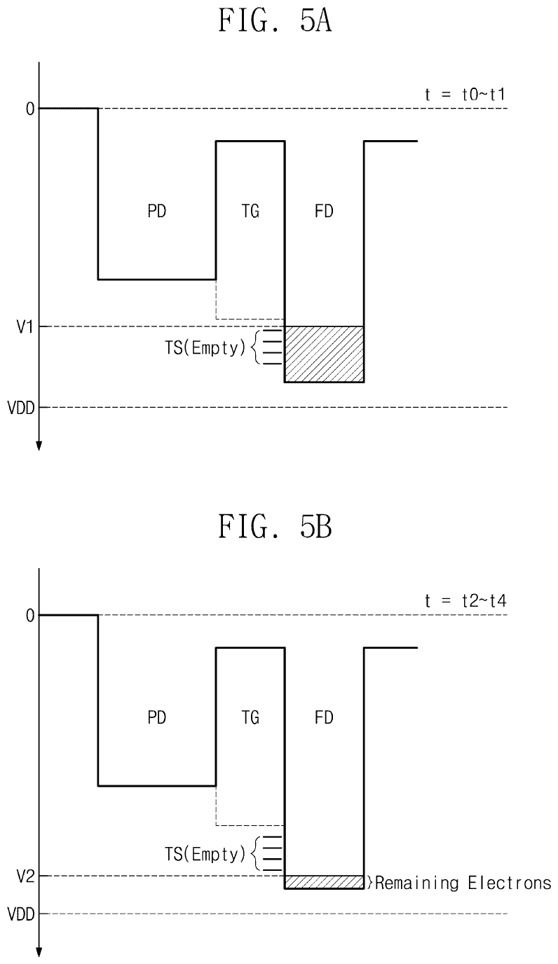

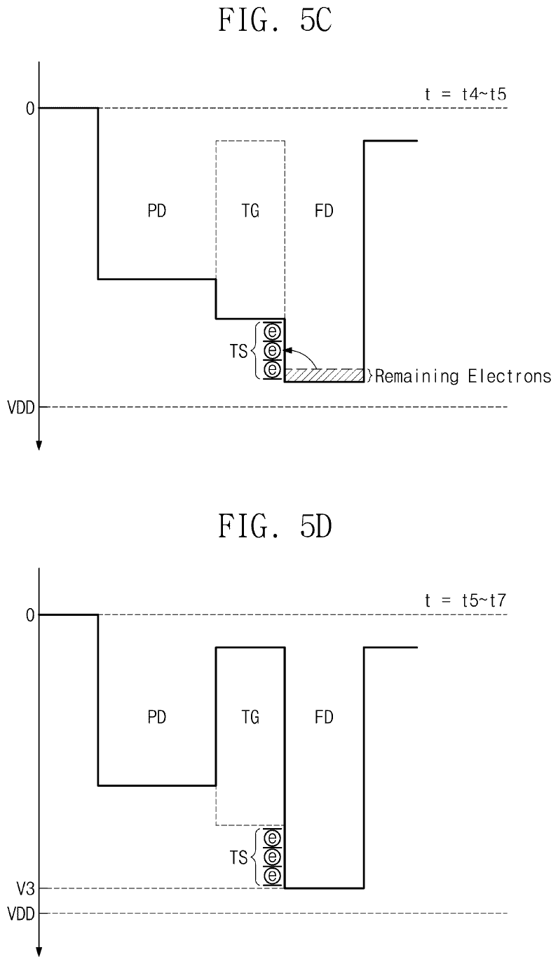

FIG. 4 is a timing diagram for describing an operation of an image sensor device including a pixel of FIG. 3. FIGS. 5A to 5D are diagrams for describing noise generated during an operation of FIG. 4. For example, FIGS. 5A to 5D are conduction band diagrams with respect to the photodiode PD, the transmission gate transistor TG, and the floating diffusion node FD. FIGS. 5A to 5D illustrate potential energy corresponding to each component. For example, the transmission gate transistor TG may be turned off and, the transmission transistor TG can provide a potential barrier between the photodiode PD and the floating diffusion node FD. For convenience of description and brevity of drawings, FIGS. 4 to 5D illustrate a case where the image sensor device 100 of FIG. 1 operates in a dark state. FIGS. 4 to 5D will be described with reference to FIGS. 1 to 3.

Referring to FIGS. 4 and 5A, during a time period between a zeroth time t0 and a first time t1, the selection signal VSEL, the reset signal VRST, and the transmission signal VT are a logic low (e.g., a logic low level). Accordingly, the floating diffusion node FD may be in a floating state. Accordingly, a voltage VFD of the floating diffusion node FD may be a first voltage V1. For example, the first voltage V1 may be greater than 0V and less than the power supply voltage VDD. Accordingly, charges may be accumulated in the floating diffusion node FD.

Referring to FIG. 5A, a trap site TS in which charges may be trapped may exist at the interface between the transmission gate transistor TG and the floating diffusion node FD. As described above, during the time period from the zeroth time t0 to the first time t1, the transmission gate transistor TG may be turned-off. For example, the potential energy of the trap site TS may be excessively higher than the potential energy of the floating diffusion node FD. Accordingly, charges accumulated in the floating diffusion node FD may not be trapped in the trap site TS. Accordingly, the trap site TS may be empty.

Referring again to FIG. 4, the reset signal VRST may be a logic high during the time period from the first time t1 to a second time t2. Accordingly, the reset transistor RST may be turned-on. Accordingly, a reset operation may be performed on the pixel PX. For example, the floating diffusion node FD of the pixel PX may be charged based on the power supply voltage VDD. Accordingly, the voltage VFD of the floating diffusion node FD may become a second voltage V2. Charges accumulated in the floating diffusion node FD may be removed by the reset operation.

Thereafter, the reset signal VRST may become a logic low at the second time t2. Accordingly, the reset transistor RST may be turned-off.

During the time period from the second time t2 to a fourth time t4, the selection signal VSEL may be a logic high. At the second time t2, the selection transistor SEL may be turned-on in response to the selection signal VSEL of a logic high. A reset sampling operation may be performed during the time period from the second time t2 to the fourth time t4. To perform the reset sampling operation, an offset may be applied to the ramp signal VRAMP (e.g. at the second time t2) and the ramp signal VRAMP may be decreased (e.g. from the third time t3 to the fourth time t4). While the reset sampling operation is performed, the voltage VFD of the floating diffusion node FD may be the same as a voltage of the pixel signal PIX (refer to the PIX of FIG. 3). Accordingly, the reset sampling voltage may be the second voltage V2.

Referring to FIG. 5B, for example, the floating diffusion node FD may be located in an n-type doped region. Therefore, even after the reset operation is performed, the charges accumulated in the floating diffusion node FD may not be completely removed. For example, even after the reset operation is performed, remaining electrons may exist in the floating diffusion node FD.

Referring again to FIG. 4, at the fourth time t4, the selection signal VSEL may become a logic low. The selection transistor SEL may be turned-off in response to the selection signal VSEL of the logic low.

During a time period from the fourth time t4 to a firth time t5, the transmission signal VT may be a logic high. The transmission gate transistor TG may be turned-on in response to the transmission signal VT of the logic high, and charges generated by the photodiode PD may move to the floating diffusion node FD. For example, the pixel PX may perform the integration operation.

However, as described above, since FIG. 4 illustrates the operation of the image sensor device 100 in the dark state, in the example of FIG. 4, charges generated by the photodiode PD may not exist. However, the voltage VFD of the floating diffusion node FD may increase from the second voltage V2 to a third voltage V3 due to a charge trap phenomenon. The charge trap phenomenon will be described in more detail below.

At the fifth time t5, the transmission signal VT may become a logic low. Accordingly, the transmission gate transistor TG may be turned-off.

During a time period from the fifth time t5 to a seventh time t7, the selection signal VSEL may be a logic high. Accordingly, at the fifth time t5, the selection transistor SEL may be turned-on. The data sampling operation may be performed during the time period from the fifth time t5 to the seventh time t7. To perform the data sampling operation, an offset may be applied to the ramp signal VRAMP (e.g. at the fourth time t4) and the ramp signal VRAMP may be decreased (e.g. from the sixth time t6 to the seventh time t7). While the data sampling operation is performed, the voltage VFD of the floating diffusion node FD may be the same as a voltage of the pixel signal PIX (refer to the PIX of FIG. 3). Accordingly, the data sampling voltage may be the third voltage V3.

At the seventh time t7, the selection signal VSEL may become a logic low and the reset signal VRST may become a logic high. Accordingly, the selection transistor SEL may be turned-off and the reset transistor RST may be turned-on.

Referring to FIGS. 4 and 5C, during the time period from the fourth time t4 to the fifth time t5, as the transmission gate transistor TG is turned-on, the potential energy of the trap site TS may be lowered. Accordingly, after the reset operation is performed, charges ‘e’ remaining in the floating diffusion node FD may be trapped in the trap site TS.

Referring to FIGS. 4 and 5D, it may take a considerable amount of time for the trapped charges ‘e’ to escape the trap site TS. Accordingly, the charges ‘e’ may be trapped in the trap site TS even at the time when the data sampling operation is performed (e.g., at a specific time between the fifth time t5 and the seventh time t7). Accordingly, despite being in the dark state, as the integration operation is performed, the number of charges accumulated in the floating diffusion node FD may decrease compared to when the reset sampling operation is performed. Accordingly, the voltage VFD of the floating diffusion node FD may increase to the third voltage V3. Accordingly, when the data sampling operation is performed, the voltage VFD of the floating diffusion node FD may be the third voltage V3, and the data sampling voltage may be the third voltage V3.

For example, despite being in the dark state, as the charges remaining in the floating diffusion node FD are trapped in the trap site TS, a voltage difference Vdiff between the data sampling voltage (e.g., V3) and the reset sampling voltage (e.g., V2) may occur.

For example, a phenomenon in which the transmission gate transistor TG is turned-on and the charges ‘e’ remaining in the floating diffusion node FD are trapped in the trap site TS may be referred to as a charge trap phenomenon.

When the integration operation is performed, the number of charges trapped in the trap site TS of each pixel of the pixel array 110 (refer to 110 in FIG. 1) may be different. Accordingly, the voltage difference Vdiff between the data sampling voltage and the reset sampling voltage may vary for each pixel. Therefore, the above-described charge trap phenomenon may cause fixed pattern noise with respect to final image data IDAT.

Although the operation of the image sensor device 100 is described with reference to FIG. 4, the inventive concepts are not limited thereto, and the timing of signals may be modified depending on implementation methods. The shape of signals in the timing diagram may be changed due to interaction (e.g., coupling, etc.) between circuits.

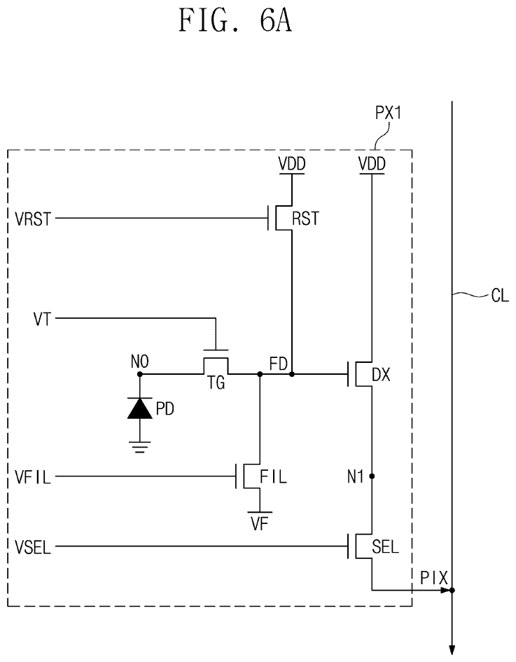

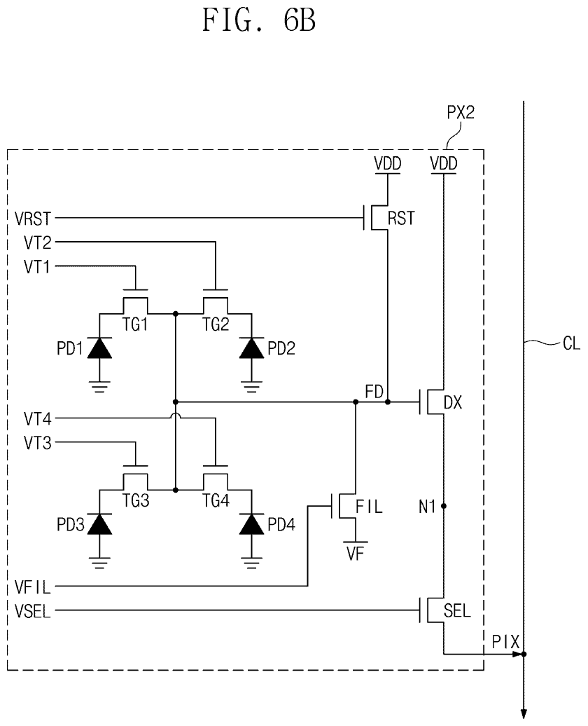

FIGS. 6A and 6B are circuit diagrams illustrating other examples of a pixel of FIG. 2. FIG. 6A illustrates a pixel PX1 with one photodiode, and FIG. 6B illustrates a pixel PX2 with four photodiodes. However, the inventive concepts are not limited to this, and the pixels PX1 and PX2 may be implemented to have various structures.

Referring to FIGS. 1 and 6A, the pixel PX1 may output the pixel signal PIX to the column line CL in response to the reset signal VRST, the transmission signal VT, and the selection signal VSEL received from the row driver 120.

For example, the pixel PX1 may include the transmission gate transistor TG, the photodiode PD, the reset transistor RST, the driving transistor DX, the selection transistor SEL, and a filler transistor FIL.

The transmission gate transistor TG, the photodiode PD, the reset transistor RST, the driving transistor DX, and the selection transistor SEL of FIG. 6A correspond to the transmission gate transistor TG, the photodiode PD, the reset transistor RST, the driving transistor DX, and selection transistor SEL of FIG. 3, respectively. Therefore, hereinafter, differences between the pixel PX of FIG. 6A and the pixel PX of FIG. 3 will be mainly described.

As described above, the pixel PX of FIG. 6A may include the filler transistor FIL, unlike the pixel PX of FIG. 3. The filler transistor FIL may be connected between the floating diffusion node FD and a filler voltage VF. The filler transistor FIL may be turned-on in response to the filler signal VFIL from the row driver 120. For example, the filler transistor FIL may be turned-on in response to the filler signal VFIL of a logic high. The turned-on filler transistor FIL may decrease the voltage of the floating diffusion node FD.

In some example embodiments, the voltage level of the filler signal VFIL having a logic high may be the same as the voltage level of the transmission signal VT of the logic high.

In some example embodiments, the filler voltage VF may be lower than the power supply voltage VDD.

In some example embodiments, the filler voltage VF may be a ground voltage.

In some example embodiments, the filler voltage VF may be lower than the maximum voltage of the zeroth node NO. For example, the transmission gate transistor TG may be turned-off and the photodiode PD may not be receiving light. For example, the voltage of the zeroth node NO may be the maximum voltage of the zeroth node NO. The maximum voltage of the zeroth node NO may mean the voltage of the zeroth node NO when charges are not generated by the photodiode PD.

In some example embodiments, the image sensor device 100 may turn on the filler transistor FIL only when operating in a low illuminance environment. For example, the illuminance of the environment in which the image sensor device 100 operates may be lower than a reference illuminance. For example, the image sensor device 100 may be referred to as operating in a low illuminance environment.

Referring to FIGS. 1 and 6B, the pixel PX2 may output the pixel signal PIX to the column line CL in response to the reset signal VRST, first to fourth transmission signals VT1 to VT4, and the selection signal VSEL received from the row driver 120.

Referring to FIG. 6B, the pixel PX2 may include transmission gate transistors TG1 to TG4, photodiodes PD1 to PD4, the reset transistor RST, the driving transistor DX, the selection transistor SEL, and the filler transistor FIL.

The reset transistor RST, the driving transistor DX, and the selection transistor SEL of the pixel PX2 in FIG. 6B correspond to the reset transistor RST, the driving transistor DX, and the selection transistor SEL of FIG. 3, respectively. The filler transistor FIL in FIG. 6B corresponds to the filler transistor FIL in FIG. 6A. Therefore, hereinafter, a difference between the pixel PX2 in FIG. 6B and the pixel PX1 in FIG. 6A will be mainly described.

The first transmission gate transistor TG1 may be connected between the first photodiode PD1 and the floating diffusion node FD, the second transmission gate transistor TG2 may be connected between the second photodiode PD2 and the floating diffusion node FD, the third transmission gate transistor TG3 may be connected between the third photodiode PD3 and the floating diffusion node FD, the fourth transmission gate transistor TG4 may be connected between the fourth photodiode PD4 and the floating diffusion node FD.

The first transmission gate transistor TG1 may operate in response to a first transmission signal VT1, the second transmission gate transistor TG2 may operate in response to a second transmission signal VT2, the third transmission gate transistor TG3 may operate in response to a third transmission signal VT3, and the fourth transmission gate transistor TG4 may operate in response to a fourth transmission signal VT4.

For example, the first transmission gate transistor TG1 may be turned-on in response to the first transmission signal VT1 of a logic high, the second transmission gate transistor TG2 may be turned-on in response to the second transmission signal VT2 of a logic high, the third transmission gate transistor TG3 may be turned-on in response to the third transmission signal VT3 of a logic high, and the fourth transmission gate transistor TG3 may be turned-on in response to the third transmission signal VT3 of a logic high. For example, charges may be moved from the first to fourth photodiodes PD1 to PD4 to the floating diffusion node FD in response to each of the first to fourth transmission signals VT1 to VT4.

In some example embodiments, the first transmission signal TG1 to the second transmission signal TG2, and/or a combination thereof may sequentially become a logic high.

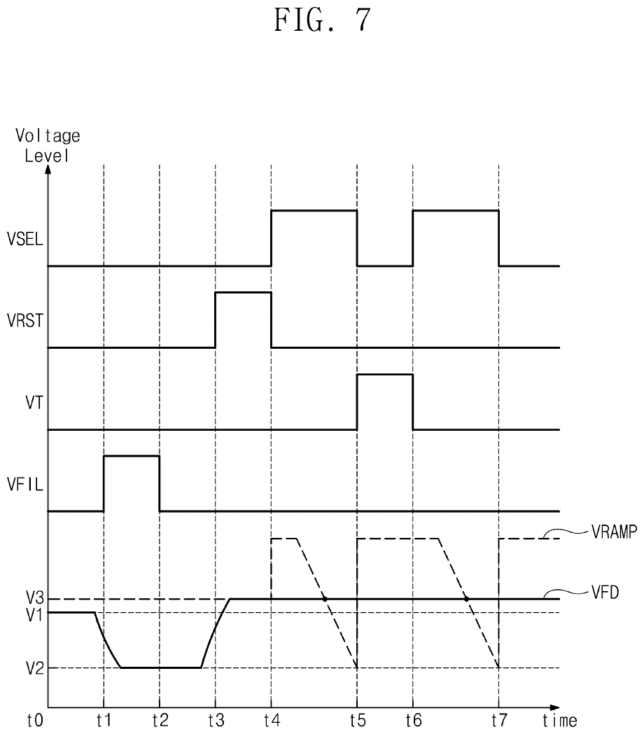

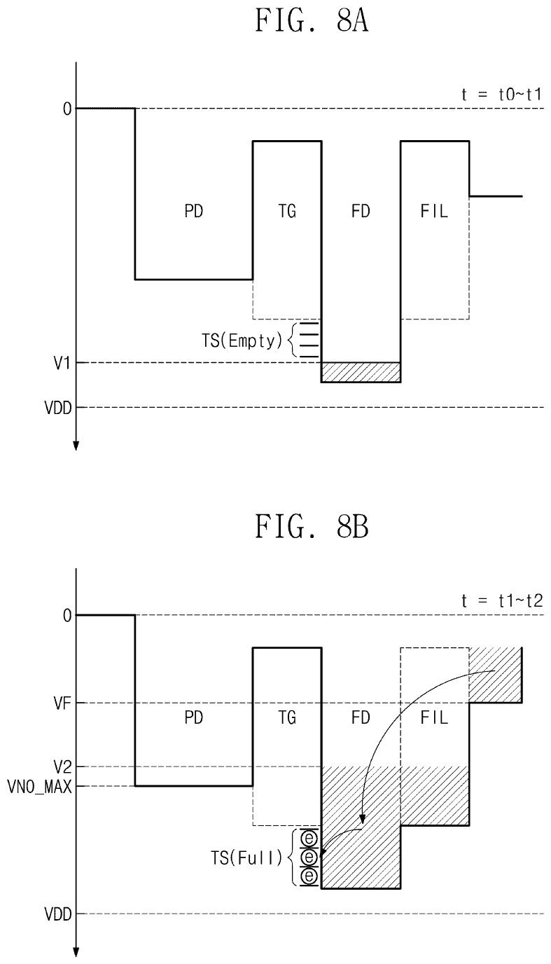

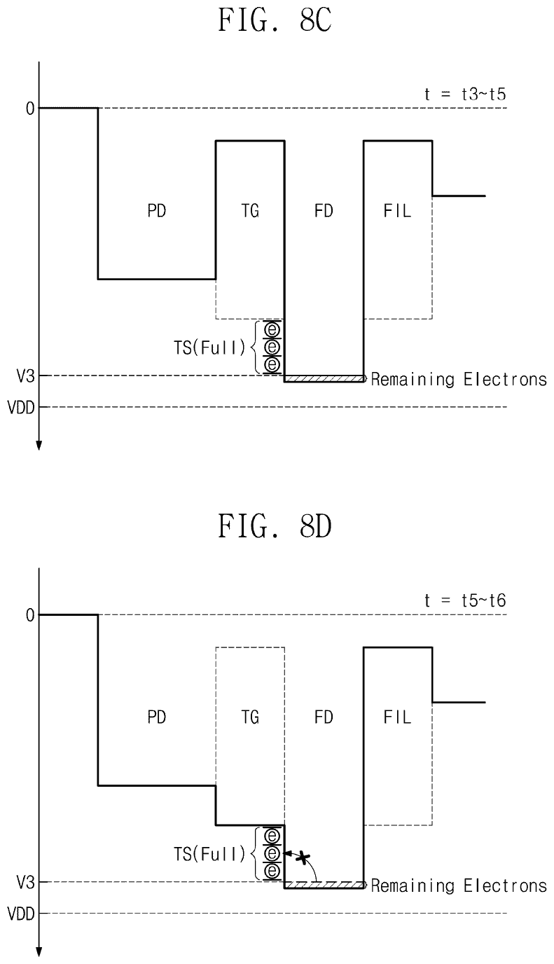

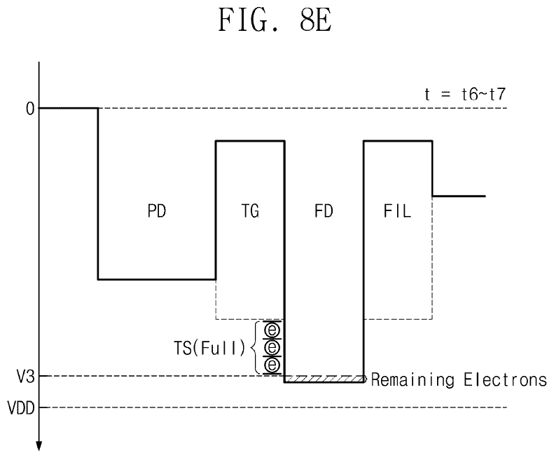

FIG. 7 is a timing diagram for describing an operation of an image sensor device of FIG. 1. FIGS. 8A to 8E are diagrams for describing an operation of FIG. 7. FIGS. 8A to 8E are conduction band diagrams with respect to the photodiode PD, the transmission gate transistor TG, the floating diffusion node FD, and the filler transistor FIL in the operation of FIG. 7. FIGS. 8A to 8E illustrate the potentials corresponding to each component. For example, the transmission gate transistor TG may be turned off, and the transmission transistor TG can provide a potential barrier between the photodiode PD and the floating diffusion node FD. In FIG. 7, it is assumed that pixels of the image sensor device 100 are implemented like the pixel PX1 in FIG. 6A. In FIGS. 8A to 8E, a vertical axis may indicate a potential level. For convenience of description and brevity of drawings, FIGS. 7 to 8E illustrate a case where the image sensor device 100 (refer to 100 in FIG. 1) operates in a dark state. FIGS. 7 to 8E will be described with reference to FIGS. 1, 2, and 6A.

Referring to FIG. 7, the operation of the image sensor device 100 is described, but the inventive concepts are not limited thereto, and the timing of signals may be modified depending on the implementation methods, the shape of signals in the timing diagram may be changed due to interaction (e.g., coupling, etc.) between circuits.

Referring to FIGS. 7 and 8A, during the time period from the zeroth time t0 to the first time t1, the selection signal VSEL, the reset signal VRST, and the transmission signal VT may be a logic low. Accordingly, the floating diffusion node FD may be in a floating state. For example, the voltage VFD of the floating diffusion node FD may be the first voltage V1. For example, the first voltage V1 may be greater than 0V and less than the power supply voltage VDD. That is, charges may be accumulated in the floating diffusion node FD. The trap site TS existing at the interface between the transmission gate transistor TG and the floating diffusion node FD may be empty.

Referring again to FIG. 7, during the time period between the first time t1 and the second time t2, the filler signal VFIL may be a logic high. The filler transistor FIL may be turned-on in response to the filler signal VFIL of the logic high. Accordingly, the voltage of the floating diffusion node FD may decrease from the first voltage V1 to the second voltage V2.

In some example embodiments, the second voltage V2 may be determined based on the filler voltage (VF in FIG. 6A) and the length of the time period from the first time t1 to the second time t2.

In some example embodiments, the second voltage V2 may be the filler voltage (VF in FIG. 6A).

In some example embodiments, the second voltage V2 may be higher than the filler voltage (VF in FIG. 6A) and lower than the maximum voltage of the zeroth node NO (refer to NO in FIG. 6A). For example, the transmission gate transistor TG may be turned-off and the photodiode PD may not be receiving light. For example, the voltage of the zeroth node NO may be the maximum voltage of the zeroth node NO. The maximum voltage of the zeroth node NO may mean the voltage of the zeroth node NO when charges are not generated by the photodiode PD.

In some example embodiments, the second voltage V2 may be a ground voltage.

In some example embodiments, the filler voltage (VF in FIG. 6A) may be lower than the maximum voltage at the zeroth node NO (refer to NO in FIG. 6A).

Referring to FIG. 8B, during the time period between the first time t1 and the second time t2, as the filler transistor FIL is turned-on, the potential energy between the floating diffusion node FD and the filler transistor FIL may decrease. Accordingly, the charges ‘e’ may move to the floating diffusion node FD through the filler transistor FIL. Accordingly, the charges ‘e’ may accumulate in the floating diffusion node FD, and the voltage VFD of the floating diffusion node FD may decrease up to the second voltage V2. For example, the second voltage V2 may be lower than a maximum voltage VN0_MAX of the zeroth node NO (refer to NO in FIG. 6A). For example, a sufficiently large number of charges ‘e’ may be accumulated in the floating diffusion node FD. Accordingly, some of the charges ‘e’ existing in the floating diffusion node FD may move to the trap site TS. Accordingly, the trap site TS may become full of the charges.

For example, to fill the trap site TS with the charges ‘e’, the second voltage V2 may have to be lower than the maximum voltage VN0_MAX of the zeroth node NO (refer to NO in FIG. 6A).

Referring again to FIG. 7, at the second time t2, the filler transistor FIL may be turned-off in response to the filler signal VFIL of a logic low.

During the time period from the third time t3 to the fourth time t4, the reset signal VRST may be a logic high. Accordingly, the reset transistor RST may be turned-on. That is, a reset operation may be performed on the pixel PX. The floating diffusion node FD of the pixel PX may be charged based on the power supply voltage VDD. Accordingly, the voltage VFD of the floating diffusion node FD may become the third voltage V3. The charges accumulated in the floating diffusion node FD may be removed by the reset operation. At the fourth time t4, the reset signal VRST may become a logic low. Accordingly, the reset transistor RST may be turned-off.

During the time period from the fourth time t4 to the fifth time t5, the selection signal VSEL may be a logic high. At the fourth time t4, the selection transistor SEL may be turned-on in response to the selection signal VSEL of a logic high. During the time period between the fourth time t4 and the fifth time t5, a reset sampling operation may be performed. To perform the reset sampling operation, an offset may be applied to the ramp signal VRAMP and the ramp signal VRAMP may be decreased. While the reset sampling operation is performed, the voltage VFD of the floating diffusion node FD may be the same as a voltage of the pixel signal PIX (refer to the PIX of FIG. 6A). Accordingly, the reset sampling voltage may be the third voltage V3.

Referring to FIG. 8C, as already described above, the charges accumulated in the floating diffusion node FD may not be completely removed even after the reset operation is performed. For example, even after the reset operation is performed, remaining electrons may exist in the floating diffusion node FD. For example, the third voltage V3 may be determined based on the number of remaining electrons in the floating diffusion node FD. Unlike the case of FIG. 5B, in the case of FIG. 8C, as the filler transistor FIL operates, the trap site TS may be full even after the reset operation is performed.

Referring again to FIG. 7, at the fifth time t5, the selection transistor SEL may be turned-off in response to the selection signal VSEL of a logic low.

During the time period from the fifth time t5 to a sixth time t6, the transmission signal VT may be a logic high. The transmission gate transistor TG may be turned-on in response to the transmission signal VT of the logic high, and charges generated by the photodiode PD may move to the floating diffusion node FD. For example, an integration operation may be performed on the pixel PX.

However, as described above, since FIG. 7 illustrates the operation of the image sensor device 100 in the dark state, in the example of FIG. 7, charges generated by the photodiode PD may not exist. According to some example embodiments of the inventive concepts, unlike the case of FIG. 4, the voltage VFD of the floating diffusion node FD may not change depending on the operation of the filler transistor FIL. This will be described in more detail with reference to FIGS. 8D and 8E.

At the sixth time t6, the transmission gate transistor TG may be turned-off in response to the transmission signal VT of a logic low.

During a time period from the sixth time t6 to a seventh time t7, the selection signal VSEL may be a logic high. Accordingly, the selection transistor SEL may be turned-on. Accordingly, the data sampling operation may be performed during the time period from the sixth time t6 to the seventh time t7. To perform the data sampling operation, an offset may be applied to the ramp signal VRAMP and the ramp signal VRAMP may be decreased. While the data sampling operation is performed, the voltage VFD of the floating diffusion node FD may be the same as a voltage of the pixel signal PIX (refer to the PIX of FIG. 3). Accordingly, the data sampling voltage may be the third voltage V3.

As described above, the charge trap phenomenon does not occur while performing the integration operation depending on (e.g., because of) the operation of the filler transistor FIL (an operation during the time period between the first time t1 and the second time t2). Accordingly, according to some example embodiments of the inventive concepts, a voltage difference between the data sampling voltage (e.g., V3) and the reset sampling voltage (e.g., V3) may not occur in the dark state. For example, according to some example embodiments of the inventive concepts, noise generation due to a charge trap phenomenon may be limited and/or prevented by the operation of the filler transistor FIL.

In particular, referring to FIG. 8D, the transmission gate transistor TG may be turned-on for the integration operation, thereby lowering the potential energy of the trap site TS. For example, the trap site TS may already be full of the charges ‘e’ according to the operation of the filler transistor FIL. Therefore, even when the potential energy of the trap site TS is lowered, there may not be a space in the trap site TS where charges may be trapped. Accordingly, the charges of the floating diffusion node FD may not be trapped in the trap site TS.

Therefore, as illustrated in FIG. 8E, the number of charges (remaining electrons) remaining in the floating diffusion node when performing a digital sampling operation may remain the same as the number of charges (remaining electrons in FIG. 8C) remaining in the floating diffusion node when performing a reset sampling operation. Accordingly, a voltage difference between the reset sampling voltage (e.g., V3) and the data sampling voltage (e.g., V3) may not occur.

For example, since the trap site TS is filled with the charges ‘e’ before performing the integration operation, noise due to the charge trap phenomenon may not occur when the integration operation is performed.

Referring to FIG. 7 again, at the seventh time t7, the selection signal VSEL may become a logic low and the reset signal VRST may become a logic high. Accordingly, the selection transistor SEL may be turned-off and the reset transistor RST may be turned-on.

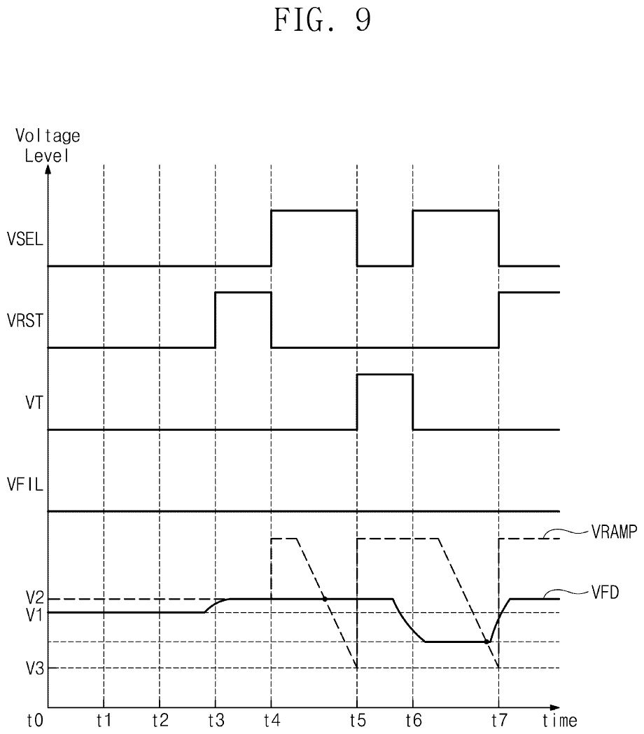

FIG. 9 is a timing diagram for describing another example of an operation of an image sensor device of FIG. 1. FIG. 9 is a timing diagram illustrating an example of the operation of the image sensor device 100 of FIG. 1 when the environment in which the image sensor device 100 of FIG. 1 operates is a high illuminance environment. For example, the high illuminance environment may refer to a case where the illuminance of the environment in which the image sensor device 100 operates is greater than a reference illuminance. In FIG. 9, it is assumed that each of the pixels of the image sensor device 100 has the same structure as the pixel PX1 in FIG. 6A.

Referring to FIG. 9, unlike the case of FIG. 7, the filler signal VFIL may maintain a logic low during the time period from the first time t1 to the second time t2. Accordingly, the filler transistor FIL may not be turned-on during the time period from the first time t1 to the second time t2. For example, in the high illuminance environment, the operation of filling the trap site TS with the charges ‘e’ may not be performed by the filler transistor FIL.

In time periods other than the time period from the first time t1 to the second time t2 in FIG. 9, the operation of the image sensor device 100 is as described above with reference to FIG. 7. For example, the image sensor device 100 may perform a reset operation on the pixel during the time period from the third time t3 to the fourth time t4, may perform a reset sampling operation during the time period from the fourth time t4 to the fifth time t5, may perform an integration operation during the time period from the fifth time t5 to the sixth time t6, and may perform a data sampling operation during the time period from the sixth time t6 to the seventh time t7. In some example embodiments, a reset sampling voltage may be the second voltage V2 and the data sampling voltage may be the third voltage V3.

For example, in the high illuminance environment where the difference between the reset sampling voltage (e.g., V2) and the data sampling voltage (e.g., V3) is large, the effect of noise due to the charge trap phenomenon occurring during the integration operation on the image data (e.g., IDAT in FIG. 1) may be small. Therefore, in the high illuminance environment, the filler transistor FIL may not be turned-on.

For example, according to some example embodiments of the inventive concepts, the image sensor device 100 may turn on the filler transistor FIL only when operating in the low illuminance environment. However, the inventive concepts are not limited to this, and in some example embodiments, the image sensor device 100 may perform an operation to fill the trap site TS with charges through the filler transistor FIL, regardless of the illuminance.

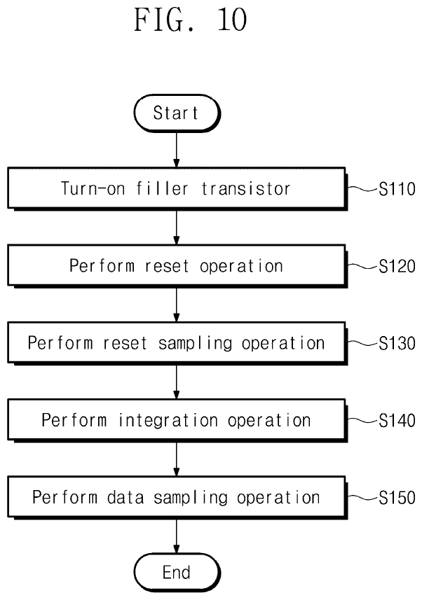

FIG. 10 is a flowchart illustrating a method of operating an image sensor device, according to some example embodiments of the inventive concepts. FIG. 10 will be described with reference to FIGS. 1, 2, and 6A to 8E.

Referring to FIG. 10, in operation S110, the image sensor device 100 may turn on the filler transistor FIL. Accordingly, the voltage of the floating diffusion node FD of the pixel (e.g., PX1) may decrease. The charges ‘e’ may be filled in the trap site TS existing between the floating diffusion node FD and the transmission gate transistor TG. Accordingly, the trap site TS may become full of charges.

In operation S120, the image sensor device 100 may perform a reset operation. For example, the image sensor device 100 may reset the floating diffusion node FD by turning on the reset transistor RST. Accordingly, charges accumulated in the floating diffusion node FD may be removed.

In operation S130, the image sensor device 100 may perform a reset sampling operation. For example, the image sensor device 100 may obtain a reset sampling voltage by comparing the ramp signal VRAMP with a voltage of the pixel signal PIX.

In operation S140, the image sensor device 100 may perform an integration operation. For example, the image sensor device 100 may turn on the transmission gate transistor TG. Even though the potential energy of the trap site TS decreases as the transmission gate transistor TG is turned-on, the trap site TS may already be full of charges. Accordingly, charges remaining in the floating diffusion node FD may not be trapped in the trap site TS.

In operation S150, the image sensor device 100 may perform a data sampling operation. For example, the image sensor device 100 may obtain a data sampling voltage by comparing the ramp signal VRAMP with the voltage of the pixel signal PIX.

According to the inventive concepts, the image sensor device 100 may turn on the filler transistor FIL before performing a reset operation on the pixel. Accordingly, the image sensor device 100 may fill the trap site TS with charges before the reset operation and the integration operation are performed. Accordingly, the image sensor device 100 may remove noise caused by a charge trap phenomenon during an integration operation. An image sensor device with improved reliability and improved performance and a method of operating the same may be provided.

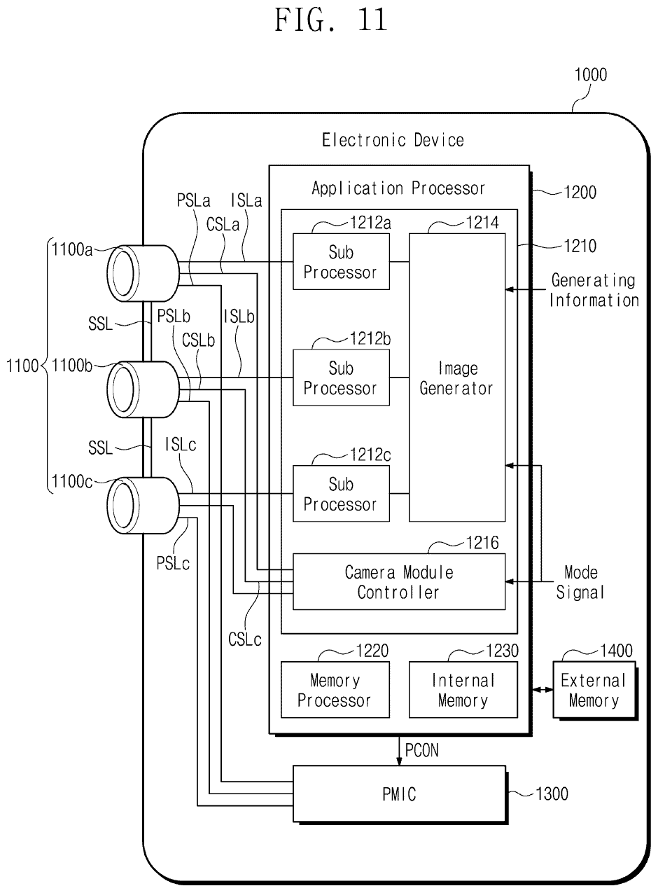

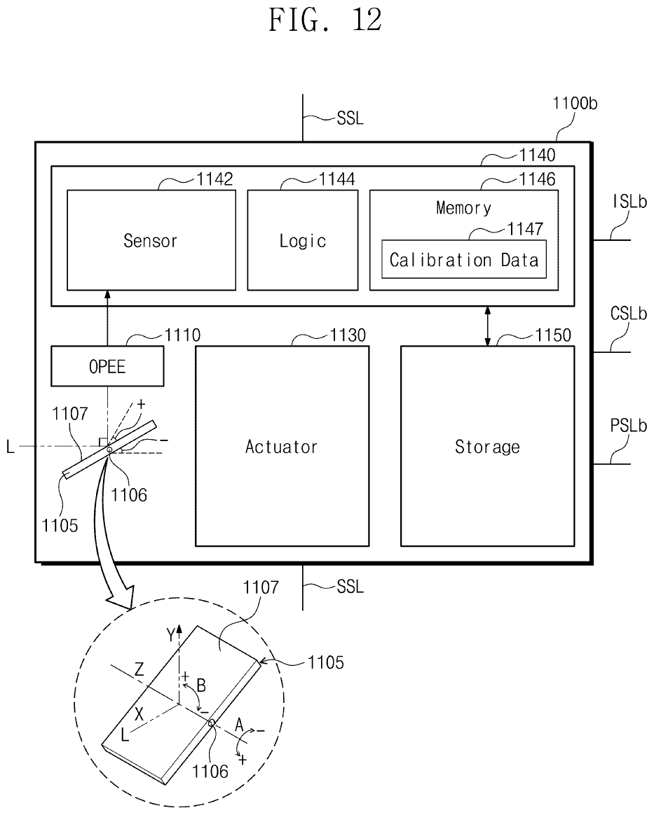

FIG. 11 is a block diagram of an electronic device including a multi-camera module. FIG. 12 is a block diagram illustrating a camera module of FIG. 11 For example.

Referring to FIG. 11, an electronic device 1000 may include a camera module group 1100, an application processor 1200, a PMIC 1300, and an external memory 1400.

The camera module group 1100 may include a plurality of camera modules 1100a, 1100b, and 1100c. An electronic device including three camera modules 1100a, 1100b, and 1100c is illustrated in FIG. 11, but the inventive concepts are not limited thereto. In some example embodiments, the camera module group 1100 may be modified to include only two camera modules. Also, in some example embodiments, the camera module group 1100 may be modified to include “n” camera modules (n being a natural number of 4 or more).

Below, a configuration of the camera module 1100b will be more fully described with reference to FIG. 12, but the following description may be equally applied to the remaining camera modules 1100a and 1100c.

Referring to FIG. 12, the camera module 1100b may include a prism 1105, an optical path folding element (OPFE) 1110, an actuator 1130, an image sensing device 1140, and storage 1150.

The prism 1105 may include a reflecting plane 1107 of a light reflecting material and may change a path of a light “L” incident from the outside.

In some example embodiments, the prism 1105 may change a path of the light “L” incident in a first direction (X) to a second direction (Y) perpendicular to the first direction (X). Also, the prism 1105 may change the path of the light “L” incident in the first direction (X) to the second direction (Y) perpendicular to the first (X-axis) direction by rotating the reflecting plane 1107 of the light reflecting material in direction “A” about a central axis 1106 or rotating the central axis 1106 in direction “B”. For example, the OPFE 1110 may move in a third direction (Z) perpendicular to the first direction (X) and the second direction (Y).

In some example embodiments, as illustrated in FIG. 12, a maximum rotation angle of the prism 1105 in direction “A” may be equal to or smaller than 15 degrees in a positive A direction and may be greater than 15 degrees in a negative A direction, but the inventive concepts are not limited thereto.

In some example embodiments, the prism 1105 may move within approximately 20 degrees in a positive or negative B direction, between 10 degrees and 20 degrees, or between 15 degrees and 20 degrees; here, the prism 1105 may move at the same angle in the positive or negative B direction or may move at a similar angle within approximately 1 degree.

In some example embodiments, the prism 1105 may move the reflecting plane 1107 of the light reflecting material in the third direction (e.g., Z direction) parallel to a direction in which the central axis 1106 extends.

The OPFE 1110 may include optical lenses composed of “m” groups (m being a natural number), for example. Here, “m” lens may move in the second direction (Y) to change an optical zoom ratio of the camera module 1100b. For example, when a default optical zoom ratio of the camera module 1100b is “ZR”, the optical zoom ratio of the camera module 1100b may be changed to an optical zoom ratio of 3ZR, 5ZR, or 5ZR or more by moving “m” optical lens included in the OPFE 1110.

The actuator 1130 may move the OPFE 1110 or an optical lens (hereinafter referred to as an “optical lens”) to a specific location. For example, the actuator 1130 may adjust a location of an optical lens such that an image sensor 1142 is placed at a focal length of the optical lens for accurate sensing.

The image sensing device 1140 may include the image sensor 1142, control logic 1144 (e.g., a control logic circuit), and a memory 1146. The image sensor 1142 may sense an image of a sensing target by using the light “L” provided through an optical lens. The control logic 1144 may control overall operations of the camera module 1100b. For example, the control logic 1144 may control an operation of the camera module 1100b based on a control signal provided through a control signal line CSLb.

The memory 1146 may store information, which is necessary for an operation of the camera module 1100b, such as calibration data 1147. The calibration data 1147 may include information necessary for the camera module 1100b to generate image data by using the light “L” provided from the outside. The calibration data 1147 may include, for example, information about the degree of rotation described above, information about a focal length, information about an optical axis, etc. For example, where the camera module 1100b is implemented in the form of a multi-state camera in which a focal length varies depending on a location of an optical lens, the calibration data 1147 may include a focal length value for each location (or state) of the optical lens and information about auto focusing.

The storage 1150 may store image data sensed through the image sensor 1142. The storage 1150 may be disposed outside the image sensing device 1140 and may be implemented in a shape where the storage 1150 and a sensor chip constituting the image sensing device 1140 are stacked. In some example embodiments, the storage 1150 may be implemented with an electrically erasable programmable read only memory (EEPROM), but the inventive concepts are not limited thereto.

Referring together to FIGS. 11 and 12, in some example embodiments, each of the plurality of camera modules 1100a, 1100b, and 1100c may include the actuator 1130. As such, the same calibration data 1147 or different calibration data 1147 may be included in the plurality of camera modules 1100a, 1100b, and 1100c depending on operations of the actuators 1130 therein.

In some example embodiments, one camera module (e.g., 1100b) among the plurality of camera modules 1100a, 1100b, and 1100c may be a folded lens shape of camera module in which the prism 1105 and the OPFE 1110 described above are included, and the remaining camera modules (e.g., 1100a and 1100c) may be a vertical shape of camera module in which the prism 1105 and the OPFE 1110 described above are not included; however, the inventive concepts are not limited thereto.

In some example embodiments, one camera module (e.g., 1100c) among the plurality of camera modules 1100a, 1100b, and 1100c may be, for example, a vertical shape of depth camera extracting depth information by using an infrared ray (IR). For example, the application processor 1200 may merge image data provided from the depth camera and image data provided from any other camera module (e.g., 1100a or 1100b) and may generate a three-dimensional (3D) depth image.

In some example embodiments, at least two camera modules (e.g., 1100a and 1100b) among the plurality of camera modules 1100a, 1100b, and 1100c may have different fields of view. For example, the at least two camera modules (e.g., 1100a and 1100b) among the plurality of camera modules 1100a, 1100b, and 1100c may include different optical lenses, but the inventive concepts are not limited thereto.

Also, in some example embodiments, fields of view of the plurality of camera modules 1100a, 1100b, and 1100c may be different. For example, the plurality of camera modules 1100a, 1100b, and 1100c may include different optical lens, but are not limited thereto.

In some example embodiments, the plurality of camera modules 1100a, 1100b, and 1100c may be disposed to be physically separated from each other. That is, the plurality of camera modules 1100a, 1100b, and 1100c may not use a sensing area of one image sensor 1142, but the plurality of camera modules 1100a, 1100b, and 1100c may include independent image sensors 1142 therein, respectively.

Returning to FIG. 11, the application processor 1200 may include an image processing device 1210, a memory controller 1220, and an internal memory 1230. The application processor 1200 may be implemented to be separated from the plurality of camera modules 1100a, 1100b, and 1100c. For example, the application processor 1200 and the plurality of camera modules 1100a, 1100b, and 1100c may be implemented with separate semiconductor chips.

The image processing device 1210 may include a plurality of sub image processors 1212a, 1212b, and 1212c, an image generator 1214, and a camera module controller 1216.

The image processing device 1210 may include the plurality of sub image processors 1212a, 1212b, and 1212c, the number of which corresponds to the number of the plurality of camera modules 1100a, 1100b, and 1100c.

Image data respectively generated from the camera modules 1100a, 1100b, and 1100c may be respectively provided to the corresponding sub image processors 1212a, 1212b, and 1212c through separated image signal lines ISLa, ISLb, and ISLc. For example, the image data generated from the camera module 1100a may be provided to the sub image processor 1212a through the image signal line ISLa, the image data generated from the camera module 1100b may be provided to the sub image processor 1212b through the image signal line ISLb, and the image data generated from the camera module 1100c may be provided to the sub image processor 1212c through the image signal line ISLc. This image data transmission may be performed, for example, by using a camera serial interface (CSI) based on the MIPI (Mobile Industry Processor Interface), but the inventive concepts are not limited thereto.

In some example embodiments, one sub image processor may be disposed to correspond to a plurality of camera modules. For example, the sub image processor 1212a and the sub image processor 1212c may be integrally implemented, not separated from each other as illustrated in FIG. 11. For example, one of the pieces of image data respectively provided from the camera module 1100a and the camera module 1100c may be selected through a selection element (e.g., a multiplexer), and the selected image data may be provided to the integrated sub image processor.

The image data respectively provided to the sub image processors 1212a, 1212b, and 1212c may be provided to the image generator 1214. The image generator 1214 may generate an output image by using the image data respectively provided from the sub image processors 1212a, 1212b, and 1212c, depending on image generating information Generating Information or a mode signal.

For example, the image generator 1214 may generate the output image by merging at least a portion of the image data respectively generated from the camera modules 1100a, 1100b, and 1100c having different fields of view, depending on the image generating information Generating Information or the mode signal. Also, the image generator 1214 may generate the output image by selecting one of the image data respectively generated from the camera modules 1100a, 1100b, and 1100c having different fields of view, depending on the image generating information Generating Information or the mode signal.

In some example embodiments, the image generating information Generating Information may include a zoom signal or a zoom factor. Also, in some example embodiments, the mode signal may be, for example, a signal based on a mode selected from a user.

In the case where the image generating information Generating Information is the zoom signal (or zoom factor) and the camera modules 1100a, 1100b, and 1100c have different visual fields of view, the image generator 1214 may perform different operations depending on a kind of the zoom signal. For example, in the case where the zoom signal is a first signal, the image generator 1214 may merge the image data output from the camera module 1100a and the image data output from the camera module 1100c and may generate the output image by using the merged image signal and the image data output from the camera module 1100b that is not used in the merging operation. In the case where the zoom signal is a second signal different from the first signal, without the image data merging operation, the image generator 1214 may select one of the image data respectively output from the camera modules 1100a, 1100b, and 1100c and may output the selected image data as the output image. However, the inventive concepts are not limited thereto, and a way to process image data may be modified without limitation if necessary.

In some example embodiments, the image generator 1214 may generate merged image data having an increased dynamic range by receiving a plurality of image data of different exposure times from at least one of the plurality of sub image processors 1212a, 1212b, and 1212c and performing high dynamic range (HDR) processing on the plurality of image data.

The camera module controller 1216 may provide control signals to the camera modules 1100a, 1100b, and 1100c, respectively. The control signals generated from the camera module controller 1216 may be respectively provided to the corresponding camera modules 1100a, 1100b, and 1100c through control signal lines CSLa, CSLb, and CSLc separated from each other.

One of the plurality of camera modules 1100a, 1100b, and 1100c may be designated as a master camera (e.g., 1100b) depending on the image generating information Generating Information including a zoom signal or the mode signal, and the remaining camera modules (e.g., 1100a and 1100c) may be designated as a slave camera. The above designation information may be included in the control signals, and the control signals including the designation information may be respectively provided to the corresponding camera modules 1100a, 1100b, and 1100c through the control signal lines CSLa, CSLb, and CSLc separated from each other.

Camera modules operating as a master and a slave may be changed depending on the zoom factor or an operating mode signal. For example, in the case where the field of view of the camera module 1100a is wider than the field of view of the camera module 1100b and the zoom factor indicates a low zoom ratio, the camera module 1100b may operate as a master, and the camera module 1100a may operate as a slave. In contrast, in the case where the zoom factor indicates a high zoom ratio, the camera module 1100a may operate as a master, and the camera module 1100b may operate as a slave.

In some example embodiments, the control signal provided from the camera module controller 1216 to each of the camera modules 1100a, 1100b, and 1100c may include a sync enable signal. For example, in the case where the camera module 1100b is used as a master camera and the camera modules 1100a and 1100c are used as a slave camera, the camera module controller 1216 may transmit the sync enable signal to the camera module 1100b. The camera module 1100b that is provided with sync enable signal may generate a sync signal based on the provided sync enable signal and may provide the generated sync signal to the camera modules 1100a and 1100c through a sync signal line SSL. The camera module 1100b and the camera modules 1100a and 1100c may be synchronized with the sync signal to transmit image data to the application processor 1200.

In some example embodiments, the control signal provided from the camera module controller 1216 to each of the camera modules 1100a, 1100b, and 1100c may include mode information according to the mode signal. Based on the mode information, the plurality of camera modules 1100a, 1100b, and 1100c may operate in a first operating mode and a second operating mode with regard to a sensing speed.

In the first operating mode, the plurality of camera modules 1100a, 1100b, and 1100c may generate image signals at a first speed (e.g., may generate image signals of a first frame rate), may encode the image signals at a second speed (e.g., may encode the image signal of a second frame rate higher than the first frame rate), and transmit the encoded image signals to the application processor 1200. For example, the second speed may be 30 times or less the first speed.

The application processor 1200 may store the received image signals, that is, the encoded image signals in the internal memory 1230 provided therein or the external memory 1400 placed outside the application processor 1200. Afterwards, the application processor 1200 may read and decode the encoded image signals from the internal memory 1230 or the external memory 1400 and may display image data generated based on the decoded image signals. For example, the corresponding one among sub image processors 1212a, 1212b, and 1212c of the image processing device 1210 may perform decoding and may also perform image processing on the decoded image signal.

In the second operating mode, the plurality of camera modules 1100a, 1100b, and 1100c may generate image signals at a third speed (e.g., may generate image signals of a third frame rate lower than the first frame rate) and transmit the image signals to the application processor 1200. The image signals provided to the application processor 1200 may be signals that are not encoded. The application processor 1200 may perform image processing on the received image signals or may store the image signals in the internal memory 1230 or the external memory 1400.

The PMIC 1300 may supply power, for example, power supply voltages to the plurality of camera modules 1100a, 1100b, and 1100c, respectively. For example, under control of the application processor 1200, the PMIC 1300 may supply a first power to the camera module 1100a through a power signal line PSLa, may supply a second power to the camera module 1100b through a power signal line PSLb, and may supply a third power to the camera module 1100c through a power signal line PSLc.

In response to a power control signal PCON from the application processor 1200, the PMIC 1300 may generate a power corresponding to each of the plurality of camera modules 1100a, 1100b, and 1100c and may adjust a level of the power. The power control signal PCON may include a power adjustment signal for each operating mode of the plurality of camera modules 1100a, 1100b, and 1100c. For example, the operating mode may include a low-power mode. For example, the power control signal PCON may include information about a camera module operating in the low-power mode and a set power level. Levels of the powers respectively provided to the plurality of camera modules 1100a, 1100b, and 1100c may be identical to each other or may be different from each other. Also, a level of a power may be dynamically changed.

For example, the image sensor device 100 described with reference to FIGS. 1, 2, and 7 to 10 may correspond to the image sensor 1142 of FIG. 12. The image sensor 1142 may include a filler transistor (e.g., FIL in FIG. 6A). The image sensor 1142 may turn on the filler transistor (e.g., FIL in FIG. 6A) before performing a reset operation on the pixel. Accordingly, the image sensor 1142 may fill the trap site TS with charges before the reset operation and integration operation are performed. Accordingly, the image sensor device 100 may remove noise generated due to the charge trap phenomenon during an integration operation.

According to some example embodiments of the inventive concepts, an image sensor device may be provided that limits and/or prevents electrons in a floating diffusion region from being trapped in a trap site when the transmission gate transistor is turned-on. Accordingly, noise caused by charge traps may be removed. Accordingly, an image sensor device having improved reliability and improved performance and an operation method thereof may be provided.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, an application-specific integrated circuit (ASIC), etc.

The above descriptions provide some example embodiments for of the inventive concepts. Some example embodiments in which a design is changed simply or which are easily changed may be included within the spirit and scope of the inventive concepts. Technologies that are easily changed and implemented by using the above example embodiments may be included in the inventive concepts. While the inventive concepts have has been described with reference to some example embodiments, it will be apparent to those of ordinary skill in the art that various changes and modifications may be made thereto without departing from the spirit and scope of the inventive concepts as set forth in the following claims.

What is claimed is:

1. An image sensor device comprising:
a pixel and a column line connected to the pixel; and
a sensor controller connected to the pixel,
wherein the pixel includes
a reset transistor connected between a power supply voltage and a floating diffusion node of the pixel,
a transmission gate transistor connected between the floating diffusion node and a zeroth node of the pixel,
a photodiode connected between the zeroth node and a ground voltage,
a filler transistor connected between a filler voltage and the floating diffusion node,
a source follower transistor connected between the power supply voltage and a first node, and
a selection transistor connected between the first node and the column line, and
wherein the sensor controller is configured to turn on the filler transistor during a first time period, and turn on the reset transistor during a second time period after the first time period.

2. The image sensor device of claim 1, wherein, during the first time period, the filler transistor is configured to decrease a voltage of the floating diffusion node from a first voltage to a second voltage lower than the first voltage.

3. The image sensor device of claim 2, wherein the second voltage is lower than a maximum voltage the zeroth node.

4. The image sensor device of claim 3, wherein the sensor controller is configured to maintain the transmission gate transistor in a turn-off state during the first and second time period, and
wherein a voltage of the zeroth node is the maximum voltage when the photodiode does not receive light.

5. The image sensor device of claim 2, wherein the second voltage is the ground voltage.

6. The image sensor device of claim 1, wherein the filler voltage is lower than the power supply voltage.

7. The image sensor device of claim 6, wherein the filler voltage is the ground voltage.

8. The image sensor device of claim 1, wherein the sensor controller is configured to operate the pixel in a low illumination environment during the first time period.

9. The image sensor device of claim 1, wherein the sensor controller is further configured to
turn on the selection transistor during a third time period after the second time period,
turn on the transmission gate transistor during a fourth time period after the third time period, and
turn on the selection transistor during a fifth time period after the fourth time period.

10. The image sensor device of claim 9, wherein during the fourth time period, a trap site between the transmission gate transistor and the floating diffusion node is fully filled with charges.

11. An image sensor device comprising:
a row driver configured to output a reset signal, a transmission signal, a selection signal, and a filler signal; and
a pixel array including a first pixel connected to a first column line,
wherein the first pixel includes
a reset transistor connected between a power supply voltage and a floating diffusion node of the first pixel, the reset transistor configured to operate in response to the reset signal,
a transmission gate transistor connected between the floating diffusion node and a zeroth node of the first pixel, the transmission gate transistor configured to operate in response to the transmission signal,
a photodiode connected between the zeroth node and a ground voltage, the photodiode configured to sense light to accumulate charges,
a filler transistor connected between a filler voltage and the floating diffusion node, the filler transistor configured to operate in response to the filler signal to connect the floating diffusion node to the filler voltage, and the filler voltage being lower than the power supply voltage,
a source follower transistor connected between the power supply voltage and a first node, the source follower transistor configured to operate in response to a voltage of the floating diffusion node, and
a selection transistor connected between the first node and the first column line, the selection transistor configured to operate in response to the selection signal.

12. The image sensor device of claim 11, wherein
during a first time period, the filler transistor is configured to decrease a voltage of the floating diffusion node from a first voltage to a second voltage lower than the first voltage by connecting the floating diffusion node to the filler voltage in response to the filler signal, and
during a second time period after the first time period, the reset transistor is configured to generate a reset voltage at the diffusion node in response to the reset signal.

13. The image sensor device of claim 12, wherein the second voltage is lower than a maximum voltage the zeroth node.

14. The image sensor device of claim 13, wherein the transmission gate transistor is configured to be in a turn-off state, and
wherein a voltage of the zeroth node is the maximum voltage when the photodiode does not receive light.

15. The image sensor device of claim 12, wherein the second voltage is the ground voltage.

16. The image sensor device of claim 11, wherein the transmission gate transistor is configured to be turned-on in response to the transmission signal having a logic high level,
wherein the filler transistor is configured to be turned-on in response to the filler signal of having a logic high level, and
wherein a voltage level of the transmission signal having the logic high level and a voltage level of the filler signal of having the logic high level are a same level.

17. A method of operating an image sensor device using a sensor controller, the image sensor device including a pixel that outputs a pixel signal, the pixel including a reset transistor connected between a power supply voltage and a floating diffusion node of the pixel, a transmission gate transistor connected between the floating diffusion node and a zeroth node of the pixel, and a filler transistor connected between a filler voltage and the floating diffusing node, the method comprising:
turning on the filler transistor to reduce a voltage of the floating diffusion node from a first voltage to a second voltage lower than the first voltage;
turning on the reset transistor to reset the floating diffusion node; and
comparing a voltage of the pixel signal with a voltage of a ramp signal.

18. The method of claim 17, wherein the filler voltage is a ground voltage.

19. The method of claim 17, wherein the turning on the filler transistor to reduce the voltage of the floating diffusion node from the first voltage to the second voltage lower than the first voltage is performed in a low illumination environment.

20. The method of claim 17, wherein the pixel further comprises:
a photodiode connected between the zeroth node and a ground node, the photodiode configured to sense light to accumulate charges, and
wherein the second voltage is lower than a maximum voltage of the zeroth node when the photodiode does not receive light.
